(19) United States
(12) Patent Application Publication
(10) Pub. No.: US 2004/0200240 A1
(43) Pub. Date: Oct. 14, 2004

(54) Fluorine-doped quartz glass article and manufacturing method thereof

(75) Inventors: Jun Abe, Gunma-ken (JP); Nobuyasu Mantoku, Gunma-ken (JP)

Correspondence Address: MCGINN & GIBB, PLLC, 8321 OLD COURTHOUSE ROAD, SUITE 200, VIENNA, VA, 22182-3817, US

(73) Assignee: Shin-Etsu Chemical Co., Ltd., Tokyo (JP)

(21) Appl. No.: 10/819,176

(22) Filed: Apr. 7, 2004

(30) Foreign Application Priority Data
Apr. 8, 2003 (JP) 2003-104142
Apr. 8, 2003 (JP) 2003-104150

(51) Int. Cl. C03B 37/075

(52) U.S. Cl. 65/397

(57) ABSTRACT

A method for manufacturing a fluorine-doped quartz glass article by sintering a porous glass preform moving in a heat zone in an atmosphere of a fluorine gas is disclosed, wherein a fluorine gas process is performed by setting a moving speed of the porous glass preform in the heat zone heated at 1000° C. or more in order that L/V is 40 minutes or more, where L is the length (mm) of a heater, and V is the moving speed (mm/min). The temperature of the heat zone may be vitrification temperature. The fluorine gas process may be performed in the heat zone which is at 1000° C. or more not to perform a vitrification process, and then the vitrification process maybe performed by increasing the temperature of the heat zone.

### BACKGROUND OF THE INVENTION

The present application claims priority from Japanese Patent Applications Nos. 2003-104142 and 2003-104150 both filed on Apr. 8, 2003, the contents of which are incorporated herein by reference.

### FIELD OF THE INVENTION

The present invention relates to a fluorine-doped quartz glass article or product and a manufacturing method thereof, suitable for manufacturing an optical fiber for optical communications.

### DESCRIPTION OF THE RELATED ART

In order to obtain desired transmission characteristics in manufacturing an optical fiber for optical communications, a clad section of the optical fiber is doped with fluorine to form a porous glass preform, and then the preform is drawn to adjust the refractive index distribution thereof.

In manufacturing a fluorine-doped quartz glass, a method of doping a porous glass preform with fluorine when forming the preform, and another method of doping a porous glass preform with fluorine when heating, sintering and vitrifying the preform are generally used.

For example, in the following Patent Documents 1 to 3, methods of doping a porous glass preform with fluorine uniformly are disclosed.

Patent Document 1 discloses that in order to obtain a fluorine-doped glass article whose refractive index distribution is uniform in the longitudinal direction, a porous glass preform is gradually inserted into a furnace in an atmosphere of a fluoride gas from its end first, and then the speed of moving the preform at a heat zone is gradually lowered.

In addition, to perform fluorine doping uniformly up to the center section of the glass, Patent Document 2 discloses that the bulk density of a porous glass preform is 0.2 to 0.7 g/cm³, and the specific surface area is 10 to 50 m²/g, and Patent Document 3 discloses that a porous glass preform is doped with fluorine where the bulk density of the peripheral section is higher than that of the center section.

It is considered that the diffusion of the fluorine gas into the porous glass preform is determined by the function of time and temperature. Meanwhile, the bulk density of the porous glass preform affects this greatly, so it is preferable that the bulk density be small in doping the center section of the porous glass preform with fluorine. Also, if the diameter of the porous glass preform is large, it is difficult for fluorine to penetrate up to the center section (cf. Patent Document 2).

However, even though porous glass preforms formed under the same condition are vitrified under the same partial pressure of a fluorine gas and the same sintering gas conditions, as long as the sintering furnaces are different, there is a problem that the condition of fluorine doping is different regardless of the bulk density or the size of diameter of porous glass preforms.

In addition, Patent Document 4 discloses that an inert gas such as He is held in an atmosphere containing a fluorine compound such as CF₄, SF₆, SiF₄, etc., whereby a porous glass preform is doped with fluorine, and then the preform is sintered and vitrified to form a fluorine-doped quartz glass.

As the fluorine compound used for doping the porous glass preform with fluorine, SiF₄ is generally used. However, if the preform is sintered and vitrified under the atmosphere of a SiF₄ gas, hydroxyl groups are contained in the obtained glass, and thus there is a problem that absorption occurs at 1385 nm in wavelength.

In addition, to obtain an anhydrous optical fiber preform, conventionally, hydroxyl groups inside a porous glass preform are forced to react to chloride, and the preform is heat-treated at 800 to 1000° C. in an atmosphere of a chloride or SOCl₂ gas and then dehydrated (of Patent Document 4).

Patent Document 1: Japanese Patent Application Laid-open No. 2002-47013

Patent Document 2: Japanese Patent Application Laid-open No. 2002-60228

Patent Document 3: Japanese Patent Application Laid-open No. 2002-114522

Patent Document 4: Japanese Patent Application Laid-open No. 1981-73636

Meanwhile, even in an optical fiber preform manufactured by the method disclosed in Patent Document 4, it is impossible to sufficiently eliminate hydroxyl groups from the glass, and there also occurs absorption at 1385 nm in wavelength.

### SUMMARY OF THE INVENTION

Therefore, it is an object of the present invention to provide a, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, a method for manufacturing a fluorine-doped quartz glass article by sintering a porous glass preform moving in a heat zone in an atmosphere of a fluorine gas is provided, wherein a fluorine gas process is performed by setting a moving speed of the porous glass preform in the heat zone heated at 1000° C. or more in order that L/V is 40 minutes or more, where L is the length (mm) of a heater, and V is the moving speed (mm/min).

The temperature of the heat zone maybe vitrification temperature.

The fluorine gas process may be performed in the heat zone which is at 1000° C. or more not to perform a vitrification process, and then the vitrification process is performed by increasing the temperature of the heat zone

The fluorine gas process may be performed by setting the moving speed of the porous glass preform in the heat zone heated at 1000° C. or more in order that L/V₁+L/V₂ is 40 minutes or more, while moving the porous glass preform at a moving speed V₁ in the heat zone which is at 1000° C. or more not to perform the vitrification process, and at a moving speed V₂ in the heat zone at vitrification temperature.

The porous glass preform may be solid or hollow.

The porous glass preform may be formed by depositing glass particles on a core rod.

According to the second aspect of the present invention, a method for manufacturing a fluorine-doped quartz glass article is provided, wherein the pressure inside a chamber is positive pressure, when a heating process is performed on a porous glass preform in an atmosphere of a fluorine gas.

The heating process may be a vitrification process.

The temperature in the vitrification process may be 1350° C. or more. The positive pressure may be 10 to 500 Pa.

The heating process may be performed to prevent external air from entering through a sealed part of the chamber.

The amount of water contained in the gas supplied into the chamber may be 3 ppm or less.

According to the third aspect of the present invention, a fluorine-doped quartz glass article manufactured by the above method, wherein the amount of hydroxyl groups is 50 ppb or less.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows the refractive index distribution profile of a fluorine-doped quartz glass obtained in Examples 1 to 5 of the present invention

FIG. 2 shows the refractive index distribution profile of a fluorine-doped quartz glass obtained in Comparative Example 1.

FIG. 3 shows a vertically cross-sectional view of an example of a sintering furnace.

FIG. 4 shows the amount of hydroxyl groups in a fluorine-doped quartz glass obtained in Example 1.

FIG. 5 shows the amount of hydroxyl groups in fluorine-doped quartz glasses obtained in Comparative Examples 1 and 2.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

When porous glass preforms are vitrified in an atmosphere of a fluorine gas, the refractive index distribution profiles of the fluorine-doped quartz glasses manufactured are different due to the individual difference of sintering furnaces used, and the temperature in a heat zone in the atmosphere of a fluorine gas and the stay time of the porous glass preform in the heat zone are significantly related to each other.

In other words, during the fluorine gas process of the porous glass preform, the moving speed of the porous glass preform is determined in consideration of the length L (mm) of the heater in order that L/V is more than 40 minutes in the heat zone heated at 1000° C. or more.

Then, the porous glass preform is doped with fluorine, sintered and vitrified in the following manner.

First, the porous glass preform is moved at a moving speed V₁ in the heat zone which is at 1000° C. or more not to perform a vitrification process, and then moved in the heat zone at a moving speed V₂ again at a temperature increased to perform the vitrification process. At this time, the moving speeds V₁ and V₂ are set in order that the total processing time of a fluorine gas defined as L/V₁+L/V₂ is 40 minutes or more.

Hereinafter, the invention will now be described based on Examples, which do not intend to limit the scope of the present invention, but exemplify the invention.

First, porous quartz tubes of 100 mm in outer diameter, 15 mm in inner diameter and 500 mm in length were manufactured under the gas supply conditions shown in Table 1 which were provided to Examples 1 to 5 and Comparative Examples 1 and 2.

TABLE 1

| Gas | Initial Condition | Normal Condition |
|---|---|---|
| H₂ | 70 (l/min) | 90 (l/min) |
| O₂ | 40 (l/min) | 40 (l/min) |
| SiCl₄ | 30 (g/min) | 60 (g/min) |

### EXAMPLE 1

After the porous quartz materials were dehydrated at 1100° C. in the atmosphere of a chloride gas, the temperature of the heater in the heat zone (the length L of the heater=140 mm) is increased up to 1350° C., and a vitrification process was performed at the moving speed V set as 3 mm/min in an atmosphere of a fluorine gas of 12 mol % in order that the fluorine processing time L/V of the porous quartz materials was 47 minutes.

FIG. 1 shows the refractive index distribution profile of the fluorine-doped quartz glass obtained. It is found that fluorine doping was uniformly performed in the diametric direction as shown in FIG. 1. Further, the horizontal axis represents the diameter from the center of the core, and the vertical axis represents the difference in specific refractive index.

### EXAMPLE 2

After the porous quartz materials were dehydrated at 1000° C. in the atmosphere of chloride, the fluorine gas process was performed at the moving speed V₁ of 4.5 mm/min with the same temperature of 1000° C. in the atmosphere of a fluorine gas of 12 mol %. Then, the temperature of the heater is increased up to 1350° C. with the partial pressure of a fluorine gas being maintained, and a vitrification process was performed at the moving speed V₂ set as 4.5 mm/min in an atmosphere of a fluorine gas of 12 mol % in order that the total processing time of a fluorine gas [L/V₁+L/V₂] was 62 minutes

The refractive index distribution profile of the fluorine-doped quartz glass obtained is shown in FIG. 1 in the same way as Example 1.

### COMPARATIVE EXAMPLE 1

After the porous quartz materials were dehydrated at 1100° C. in the atmosphere of a chloride gas, the temperature of the heater in the heat zone (L=140 mm) is increased up to 1400° C., and a vitrification process was performed at the moving speed V set as 4 mm/min in an atmosphere of a fluorine gas of 12 mol % in order that the fluorine processing time L/V of the porous quartz materials was 35 minutes.

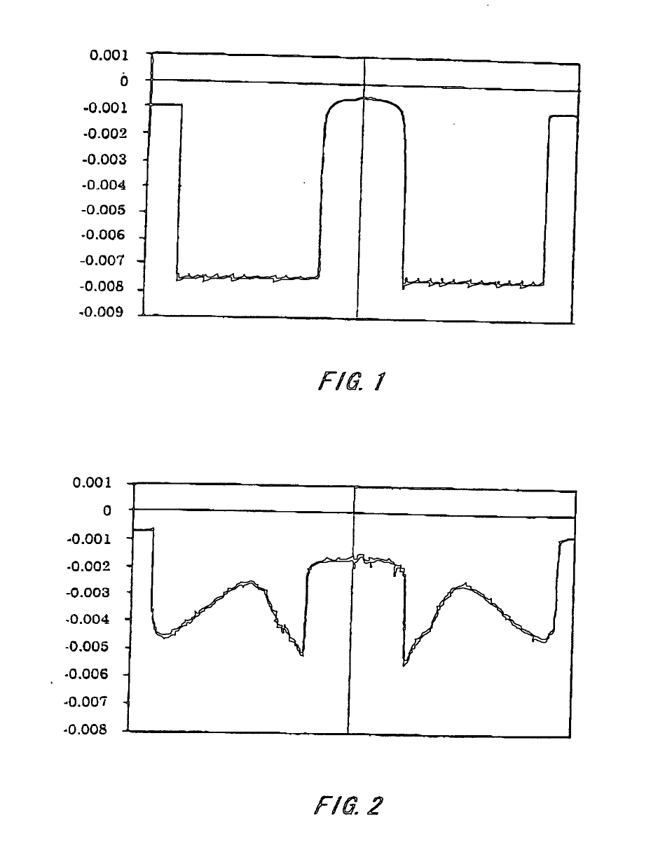

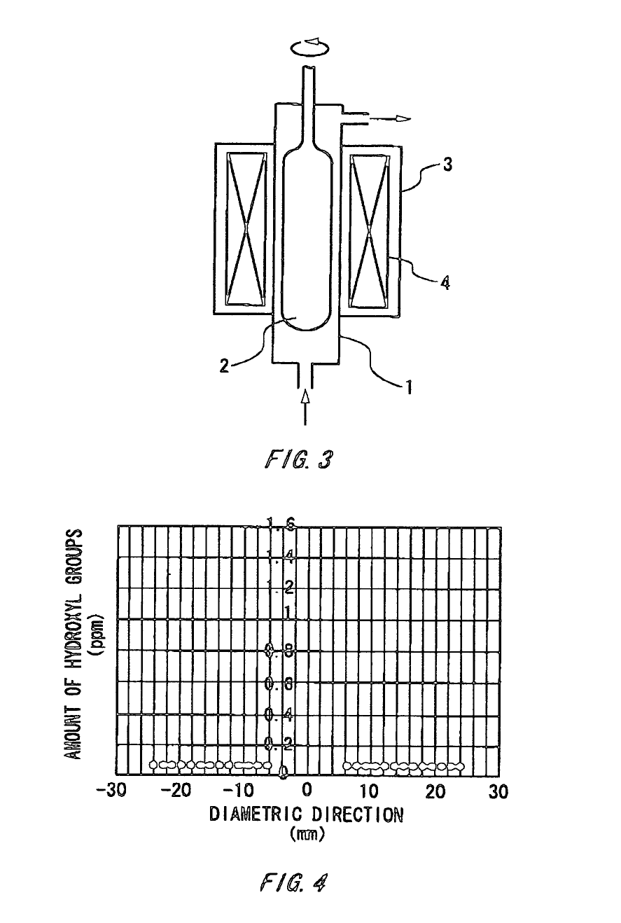

FIG. 2 shows the refractive index distribution profile of the fluorine-doped quartz glass obtained. It is found that fluorine doping was not uniformly performed in the diametric direction as shown in FIG. 2.

### EXAMPLE 3

After the porous quartz materials were dehydrated at 1100° C. in the atmosphere of chloride, the temperature of the heater in the heat zone (L=140 mm) is increased up to 1400° C., and a vitrification process was performed at the moving speed V set as 2 mm/min in the atmosphere of a fluorine gas of 12 mol % in order that the fluorine processing time L/V of the porous quartz materials was 70 minutes.

The refractive index distribution profile of the fluorine-doped quartz glass obtained shows that fluorine doping was uniformly performed in the diametric direction as shown in FIG. 1.

### EXAMPLE 4

A similar experiment was performed at the same temperature of the heater and moving speed V as those in Comparative Example 1 in the sintering furnace whose length L of the heater is 300 mm. The fluorine processing time defined as L/V was 75 minutes.

The refractive index distribution profile of the fluorine-doped quartz glass obtained shows that fluorine doping was performed uniformly in the diametric direction as shown in FIG. 1.

### COMPARATIVE EXAMPLE 2

A similar experiment was performed at the same temperature of the heater and moving speed V as those in Comparative Example 1 and Example 4 in a sintering furnace whose length L of the heater is short (L=60 mm). The fluorine processing time defined as L/V was 15 minutes. In this case, the porous quartz material was not vitrified.

### EXAMPLE 5

A fluorine gas process and a vitrification process were performed at the same temperature at a changed moving speed in the same sintering furnace used in Comparative Example 1, and a fluorine-doped quartz glass was obtained, where fluorine doping was uniformly performed as shown in FIG. 1

Further, the sintering conditions of Examples 1 to 5 and Comparative Examples 1 and 2 are shown in Table 2. The evaluation criteria are represented as “∘” in case fluorine doping was performed entirely and uniformly, “Δ” in case it was difficult to dope the center section with fluorine, and “x” in case none was vitrified, respectively.

TABLE 2

| | | | | | Fluorine Gas | | |
|---|---|---|---|---|---|---|---|
| | Dehydration | | Vitrification | | Process | | |
| | | Moving | | Moving | Length | | |
| | | Speed | | Speed | Of | | |
| | Temp. | V | Temp. | V | Heater | L/V | |
| | (° C.) | (mm/min) | (° C.) | (mm/min) | L (mm) | (min) | Evaluation |
| Example 1 | 1100 | 4 | 1350 | 3 | 140 | 47 | ◯ |
| Example 2 | 1000 | 4 | 1350 | 4.5 | 140 | 62 | ◯ |
| Comparative | 1100 | 4 | 1400 | 4 | 140 | 35 | Δ |
| Example 1 | | | | | | | |
| Example 3 | 1100 | 4 | 1400 | 2 | 140 | 70 | ◯ |
| Example 4 | 1100 | 4 | 1400 | 4 | 300 | 75 | ◯ |
| Comparative | 1100 | 4 | 1400 | 4 | 60 | 15 | X |
| Example 2 | | | | | | | |
| Example 5 | 1100 | 4 | 1400 | 1 | 60 | 60 | ◯ |

Next, the second aspect of the present invention will be described. When the sintering and vitrification processes are performed in the atmosphere of SiF₄ as described above, hydroxyl groups are contained in the obtained glass. However, if the vitrification process is performed in the atmosphere of an inert gas such as He, N₂, Ar, etc., hydroxyl groups are not contained.

Accordingly, as the result of the experiments, it is found that a SiF₄ gas reacts to a small amount of the water inside a chamber during the vitrification process and is taken into the glass as it is. Here, it is most important to eliminate the water inside the chamber, so that the pressure inside the chamber is managed, and seal sites are seen again to accomplish this invention.

A method for manufacturing a fluorine-doped quartz glass article of this invention will be described in further detail referring to FIG. 3.

A porous glass preform 2 hanged inside a chamber 1 is vitrified in the atmosphere of a SiF₄ gas at 1350° C. or more under the positive pressure of 10 to 500 Pa. The reason why the inside of the chamber 1 is under the positive pressure of 10 to 500 Pa is to prevent the external air from entering it.

As the atmosphere gas, an inert gas such as He, N₂, Ar, etc. is supplied from the lower section of the chamber 1 as shown by the arrow together with a SiF₄ gas for fluorine doping, and discharged from the upper section thereof to maintain predetermined pressure. During this time, the porous glass preform 2 is rotated in the chamber 1 by a hanging and rotating mechanism not shown, heated by a heater 4, and vitrified.

The reason why the inside of the chamber 1 is under the positive pressure of 10 to 500 Pa is that it is imperfect to prevent the external air from entering it in case of 10 Pa or lower, and it is difficult to balance the pressure inside the furnace and chamber 1 in case of 500 Pa or higher. At this time, the amount of the water in the gas supplied into the chamber 1 is 3 ppm or less. If the amount exceeds this level, it is impossible to sufficiently eliminate hydroxyl groups.

Further, it is preferable that the chamber 1 be sealed sufficiently in order to prevent the external air from entering through the sealed part.

Hereinafter, the invention will now be described based on Examples, which do not intend to limit the scope of the present invention, but exemplify the invention.

In the following Example 6 and Comparative Examples 3 and 4, porous quartz materials consisting of pure quartz glass manufactured by VAD in advance were used.

### EXAMPLE 6

After the porous quartz materials were dehydrated at 1100° C. in the atmosphere of chloride, a vitrification process was performed at the temperature of 1400° C. in the atmosphere of a SiF₄ gas of 12 mol %. During this time, the pressure inside the chamber was changed within the range of 100 to 500 Pa to maintain the positive pressure.

A quartz glass was manufactured in order not to allow the external air to enter from the sealed part of the chamber, as the amount of the water in the gas supplied to the chamber was regulated less than 3 ppm.

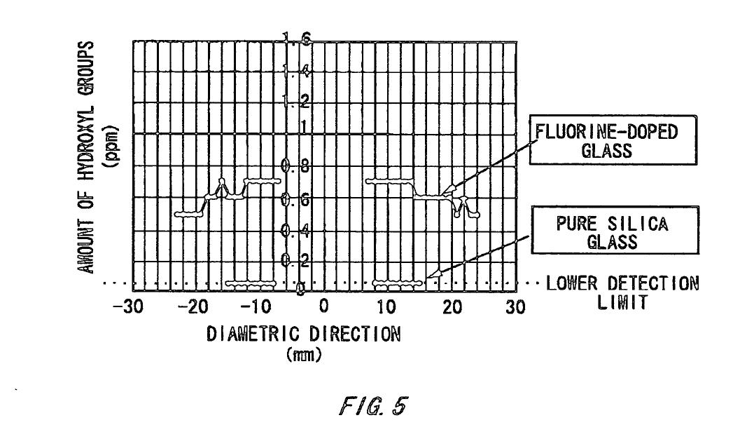

As the result of performing IR analysis of hydroxyl groups inside the fluorine-doped quartz glass obtained, the hydroxyl groups were 0.05 ppm or less as shown in FIG. 4, which was the lower detection limit of the IR measurement device.

### COMPARATIVE EXAMPLE 3

After the porous quartz materials were dehydrated at 1100° C. in the atmosphere of chloride, a vitrification process was performed at the temperature of 1400° C. in the atmosphere of a SiF₄ gas of 12 mol %. During this time, the pressure inside the chamber was changed within the range of −100 to 9 Pa. The amount of the water in the gas supplied to the chamber was 3 ppm.

As the result of performing IR analysis of hydroxyl groups inside the fluorine-doped quartz glass obtained, the hydroxyl groups of 0.6 ppm more or less were contained as shown in FIG. 5.

### COMPARATIVE EXAMPLE 4

After the porous quartz materials were dehydrated at 1100° C. in the atmosphere of chloride, a pure silica glass was obtained at the temperature of 1460° C. in the atmosphere of an inert gas of He. During this time, the pressure inside the chamber was changed within the range of −100 to 9 Pa.

As the result of performing IR analysis of hydroxyl groups inside the pure silica class obtained, the hydroxyl groups were equal to or less than the lower detection limit of the IR measurement device as shown in FIG. 5.

As obvious from the description above, according to the present invention, although a fluorine gas process and a vitrification process are performed by using different furnaces, as long as porous glass preforms have the same gas composition and bulk density, it is possible to obtain fluorine-doped quartz glasses having the same fluorine doping condition, i.e. the same refractive index distribution profile.

In addition, according to the present intention, it is possible to easily obtain a fluorine-doped quartz glass having a little amount of hydroxyl groups.

Although the present invention has been described by way of exemplary embodiments, it should be understood that those skilled in the art might make many changes and substitutions without departing from the spirit and the scope of the present invention which is defined only by the appended claims.

What is claimed is:

1. A method for manufacturing a fluorine-doped quartz glass article by sintering a porous glass preform moving in a heat zone in an atmosphere of a fluorine gas, wherein a fluorine gas process is performed by setting a moving speed of said porous glass preform in said heat zone heated at 1000° C. or more in order that L/V is 40 minutes or more, where L is length (mm) of a heater, and V is said moving speed (mm/min).

2. A method for manufacturing a fluorine-doped quartz glass article as claimed in claim 1, wherein temperature of said heat zone is vitrification temperature.

3. A method for manufacturing a fluorine-doped quartz glass article as claimed in claim 1, wherein said fluorine gas process is performed in said heat zone which is at 1000° C. or more not to perform a vitrification process, and then said vitrification process is performed by increasing said temperature of said heat zone.

4. A method for manufacturing a fluorine-doped quartz glass article as claimed in claim 3, wherein said fluorine gas process is performed by setting said moving speed of said porous glass preform in said heat zone heated at 1000° C. or more in order that L/V₁+L/V₂ is 40 minutes or more, while moving said porous glass preform at a moving speed V₁ in said heat zone which is at 1000° C. or more not to perform said vitrification process, and at a moving speed V₂ in said heat zone at vitrification temperature.

5. A method for manufacturing a fluorine-doped quartz glass article as claimed in claim 1, wherein said porous glass preform is solid.

6. A method for manufacturing a fluorine-doped quartz glass article as claimed in claim 1, wherein said porous glass preform is hollow.

7. A method for manufacturing a fluorine-doped quartz glass article as claimed in claim 1, wherein said porous glass preform is formed by depositing glass particles on a core rod.

8. A method for manufacturing a fluorine-doped quartz glass article, wherein the pressure inside a chamber is positive pressure, when a heating process is performed on a porous glass preform in an atmosphere of a fluorine gas.

9. A method for manufacturing a fluorine-doped quartz glass article as claimed in claim 8, wherein said heating process is a vitrification process.

10. A method for manufacturing a fluorine-doped quartz glass article as claimed in claim 9, wherein temperature in said vitrification process is 1350° C. or more.

11. A method for manufacturing a fluorine-doped quartz glass article as claimed in claim 8, wherein said positive pressure is 10 to 500 Pa.

12. A method for manufacturing a fluorine-doped quartz glass article as claimed in claim 8, wherein said heating process is performed to prevent external air from entering through a sealed part of said chamber.

13. A method for manufacturing a fluorine-doped quartz glass article as claimed in claim 8, wherein amount of water contained in said gas supplied into said chamber is 3 ppm or less.

14. A fluorine-doped quartz glass article manufactured by said method as claimed in claim 8, wherein amount of hydroxyl groups is 50 ppb or less.
